(19) United States
(12) Patent Application Publication
(10) Pub. No.: US 2022/0024780 A1
(43) Pub. Date: Jan. 27, 2022

(54) METHOD FOR SYNTHESIZING TUNGSTEN OXIDE NANOPARTICLES

(71) Applicant: GENES'INK SA, Rousset (FR)

(72) Inventors: Stephanie LIMAGE, La Bouilladisse (FR); Corinne VERSINI, Aix en Provence (FR); Louis-Dominique KAUFFMANN, Aix en Provence (FR); Virginie EL QACEMI, Roquevaire (FR)

(73) Assignee: GENES'INK SA, Rousset (FR)

(21) Appl. No.: 17/309,622

(22) PCT Filed: Dec. 4, 2019
(86) PCT No.: PCT/EP2019/083640

§ 371 Date: Jun. 10, 2021

(30) Foreign Application Priority Data
Dec. 13, 2018 (FR) 1872893

(51) Int. Cl. C01G 41/02

(52) U.S. Cl. CPC C01G 41/02; B82Y 40/00; C01P 2004/64

(57) ABSTRACT

The present invention relates to a method for synthesizing tungsten oxide nanoparticles and to the tungsten oxide nanoparticles obtainable on the basis of the claimed synthesis method.

The present invention relates to a method for synthesizing tungsten oxide nanoparticles. The present invention also relates to the tungsten oxide nanoparticles obtainable on the basis of the claimed synthesis method. More particularly, the present invention concerns tungsten oxide nanoparticles which can be formulated into an extended range of inks that can be used advantageously in numerous applications.

Tungsten trioxide (WO3) possesses a very broad field of potential applications by virtue of its highly promising properties. Illustrative examples are uses in the sector of solar cells, of lithium batteries, of photocatalysis, of gas sensors, as electrochromic and/or electronic devices, and in the form of supercapacitor electrodes.

A major drawback of the synthesis methods available lies in their inability to permit the preparation, using a single, reproducible synthesis method, of a tungsten trioxide which has the morphology and the properties allowing it to be used subsequently in a large number of the above-recited applications.

One of the most widespread methods for synthesizing tungsten oxide involves dissolving sodium tungstate Na2WO4.2H2O in water and admixing the solution with hydrochloric acid HCl until a gel is obtained, and subsequently dissolving said gel to give a stabilized dispersion. This technique exhibits the aforementioned drawbacks for various reasons, including, for example, the difficulty of characterizing the intermediate gel, the difficulty of its reproducibility, and a level of impurities which is not compatible with a reliable industrial utilization.

The article by Sun et al. in J. Mater. Res. Vol. 15, No. 4 of April 2000, page 927, entitled “Nanocrystalline tungsten oxide thin film:” is a good representative of this type of synthesis from sodium tungstate. It says on page 928, left-hand column, that obtaining the white gelatinous precipitate—which is not characterized—indeed constitutes an essential synthesis step in said process, with the aforementioned drawbacks which this implies.

An objective of the present invention is to overcome one or more drawbacks of the prior art by providing an alternative synthesis method which permits the simple and reproducible preparation of tungsten trioxide nanoparticles which can be formulated into a large number of different inks, allowing them accordingly to be used in a large number of applications.

According to one embodiment of the present invention, this objective is achieved by virtue of a method for synthesizing tungsten oxide nanoparticles, comprising the following consecutive steps:
a) dissolving a halogenated tungsten compound in an alcohol having a standard boiling point of greater than or equal to 120° C., preferably greater than or equal to 150° C.,
b) controlling the temperature to a value of between 60° C. and the standard boiling point of the alcohol less 5° C., preferably between 70° C. and 100° C.,
c) adding oxalic acid,
d) controlling the temperature to a value of between 80° C. and the standard boiling point of the alcohol less 5° C., preferably a temperature at least greater than the temperatures of step b), and
e) obtaining tungsten oxide nanoparticles comprising oxalic acid ligands.

Any halogenated tungsten compound may advantageously be used in the context of the present invention, for example tungsten compounds comprising chlorine, bromine, iodine or fluorine atoms and/or of a mixture of two or more of these atoms and also, optionally, one or more oxygen atoms. Illustrative examples are tungsten(II) bromide, tungsten(II) chloride, tungsten(II) iodide, tungsten(III) bromide, tungsten(III) chloride, tungsten(IV) tetrachloride, tungsten(V) bromide, tungsten(V) chloride, tungsten(V) fluoride, tungsten(V) oxytribromide, tungsten(V) oxytrichloride, tungsten(VI) bromide, tungsten(VI) chloride, tungsten(VI) dioxydibromide, tungsten(VI) dioxydichloride, tungsten(VI) dioxydiiodide, tungsten(VI) fluoride, tungsten(VI) oxytetrabromide, tungsten(VI) oxytetrachloride, tungsten(VI) oxytetrafluoride, and tungsten(VI) halides. In one preferred embodiment according to the present invention, tungsten hexachloride is used. Tungsten hexachloride of any provenance may advantageously be used in the context of the present invention. Preference will be given to commercial compounds displaying a degree of purity of more than 98% by weight, preferably more than 99% by weight, of tungsten hexachloride. As an illustration, the examples of the present invention were carried out with a tungsten hexachloride (CAS number 13283-01-7) from Alfa Aesar with the following characteristics: 99%, formula WCl6, molecular weight 396.57, in powder form, melting point 275° C., boiling point 346° C. and density 3.52.

Any alcohol may advantageously be used in the context of the present invention, provided that it meets the condition of a standard boiling point (i.e. at a pressure of one atmosphere (1013.25 hPa)) of greater than or equal to 120° C., preferably greater than or equal to 150° C., for example a polyol and/or a polyol derivative. Examples include glycols (for example ethylene glycol, propylene glycol, diethylene glycol, trimethylene glycol, 1,3-butylene glycol, 1,2-butylene glycol, 2,3-butylene glycol, pentamethylene glycol, hexylene glycol, etc.), and/or glycol ethers (for example glycol monoethers or diethers, examples of which include ethylene glycol propyl ether, ethylene glycol butyl ether, ethylene glycol phenyl ether, propylene glycol phenyl ether, diethylene glycol methyl ether, diethylene glycol ethyl ether, diethylene glycol propyl ether, diethylene glycol butyl ether, propylene glycol methyl ether, propylene glycol butyl ether, propylene glycol propyl ether, ethylene glycol dibutyl ether, diethylene glycol diethyl ether, dibutylene glycol diethyl ether, diglymes, ethyl diglyme, butyl diglyme), and/or glycol ether acetates (for example 2-butoxyethyl acetate, diethylene glycol monoethyl ether acetate, diethylene glycol butyl ether acetate, propylene glycol methyl ether acetate), and/or a mixture of two or more of said aforementioned solvents. In one preferred embodiment according to the present invention, the alcohol used is a glycol, for example ethylene glycol or, preferably, diethylene glycol. Alcohol of any provenance may advantageously be used in the context of the present invention. Preference will be given to commercial compounds displaying a degree of purity of more than 98% by weight, preferably of more than 99% by weight, of alcohol.

A mixture of two (or more) different alcohols may be used as a solvent for the halogenated tungsten compound, provided that one of the alcohols (preferably the alcohol with the highest concentration in the mixture) meets the condition of a standard boiling point of greater than or equal to 120° C., preferably greater than or equal to 150° C.; preferably, in the case of a mixture of alcohols, all of the alcohols present meet the condition of a standard boiling point of greater than or equal to 120° C., preferably greater than or equal to 150° C.

Although it does not constitute a preferred variant of the synthesis method according to the present invention, an additional, non-alcoholic solvent will also be tolerated during step a).

In one particular embodiment according to the present invention, the alcohol selected is a glycol, for example an unsubstituted glycol, more particularly ethylene glycol, preferably diethylene glycol; it represents preferably at least 90% by weight of the solvent used in step a), preferably at least 95%, at least 99%, and even 100% by weight.

In one particular embodiment according to the present invention, the solution obtained at the outcome of steps a) and b) is a clear, blue-coloured solution. In one particular embodiment according to the present invention, the solution obtained at the outcome of steps a) and b) is characterized by a molar ratio of the halogenated tungsten compound (for example tungsten hexachloride (WCl6)) to the alcohol (for example diethylene glycol) of between 0.001 and 0.5, for example between 0.005 and 0.1, preferably between 0.010 and 0.025.

Oxalic acid of any provenance may advantageously be used in the context of the present invention. Preference will be given to commercial compounds displaying a degree of purity of more than 98% by weight, preferably of more than 99% by weight, of oxalic acid. Although it does not constitute a preferred variant of the synthesis method according to the present invention, it will also be possible to use oxalic acid dihydrate.

In one particular embodiment according to the present invention, the oxalic acid is first dissolved before being used in the aforementioned step c). As an illustration, this dissolution may advantageously take place in water. In one particular embodiment according to the present invention, the temperature of the oxalic acid solution is controlled and/or heated such that this temperature is at least 25° C., preferably at least 40° C., before it is used in the aforementioned step c); this temperature will be, for example, less than 90° C., preferably less than 80° C. In one particular embodiment according to the present invention, before being used in step c), the oxalic acid is in the form of a clear, colourless solution. In one particular embodiment according to the present invention, before it is used in step c), the oxalic acid solution is characterized by a molar ratio of the oxalic acid to the water of between 0.0005 and 0.5, for example between 0.001 and 0.1, preferably between 0.005 and 0.020.

In one particular embodiment according to the present invention, step c) is characterized in that the colouration of the reaction medium turns into a dark blue colour. In one particular embodiment according to the present invention, step c) is characterized by a molar ratio of the halogenated tungsten compound (for example tungsten hexachloride (WCl6)) to the solvent (for example diethylene glycol and water) of between 0.0001 and 0.1, for example between 0.0005 and 0.030, preferably between 0.001 and 0.015, said ratio corresponding to the number of moles of WCl6 divided by the sum total of the number of moles of diethylene glycol and the number of moles of water.

In one particular embodiment according to the present invention, step c) is characterized by a molar ratio of the oxalic acid to the solvent (preferably diethylene glycol and water) of between 0.0005 and 0.2, for example between 0.001 and 0.05, preferably between 0.004 and 0.012, said ratio corresponding to the number of moles of oxalic acid divided by the sum total of the number of moles of diethylene glycol and the number of moles of water.

In one particular embodiment according to the present invention, step c) is characterized by a molar ratio of the tungsten hexachloride (WCl6) to the oxalic acid between 0.25 and 0.75, for example between 0.4 and 0.6, preferably between 0.45 and 0.55.

The Applicant has found that the synthesis method according to the present invention provides access to tungsten oxide nanoparticles comprising oxalic acid ligands that have been unobtainable with the existing synthesis methods. These new nanoparticles are characterized by superior morphology and a superior content of oxalic acid ligands.

Without wishing to be tied to this explanation, the Applicant thinks that the production of the versatile nanoparticles, namely nanoparticles exhibiting different morphologies and contents of oxalic acid ligands, has been enabled by the combination of the synthesis steps as defined above, and more particularly by the control of the variation in temperature and the concentration of oxalic acid during steps c) and d). Accordingly, the present invention also concerns the use of the claimed synthesis method for producing tungsten oxide nanoparticles with morphologies and contents of oxalic acid ligands that are controlled via the variation in temperature and in oxalic acid concentration during steps c) and d) of the synthesis method; thereby making these nanoparticles universal, meaning that they can be formulated into inks intended for a variety of applications.

Furthermore, the Applicant has also found that the tungsten oxide nanoparticles thus obtained can be formulated into a large number of different inks, allowing them to be used accordingly in a large number of applications. This broad possibility of uses and applications as ink appears likewise to be enabled by the maintenance of a liquid phase during the synthesis of the tungsten oxide nanoparticles, through to the formulation of the inks comprising said nanoparticles and their end use. Accordingly, as illustrated hereinafter, according to one particular embodiment of the present invention, a liquid phase is always present during the steps of preparing the tungsten oxide nanoparticles, and during all of the steps (for example the washing and purifying steps referred to below) before the addition of other compounds used for ink formulations. In other words, in a characteristic preferred according to the present invention, the tungsten oxide nanoparticles are never isolated and dried prior to their end use as an ink; preferably, therefore, they remain continually in contact with a liquid phase (for example a solvent) in which they are dispersed. This approach also allows any step of isolating/drying the nanoparticles to be omitted, with a consequent positive impact in terms of production costs and of individual health and safety; moreover, the Applicant thinks that the isolation/drying steps would inevitably lead to partial or even total destruction of the oxalic acid ligands, thereby negating the possibility of benefitting from the advantages of the present invention.

In one particular embodiment according to the present invention, the tungsten oxide nanoparticles obtained in step e) of the method claimed are subjected to washing which allows removal of everything not chemically or physically bonded to the nanoparticles. This washing is carried out preferably with alcohol; as an illustrative example, a monohydric aliphatic alcohol can be used which is preferably selected from the group consisting of ethanol, propanol, butanol, pentanol and hexanol and also their isomers (for example isopropanol, n-butanol, tert-butanol), and/or a mixture of two or more of said monohydric aliphatic alcohols. Ethanol is the preferred alcohol, and the tungsten oxide nanoparticles are subsequently kept preferably in ethanol. The washing may also advantageously be performed by centrifuging and/or gravity settling. The final solution obtained is preferably characterized by a concentration of more than 25 mg/g of WO3-x.xH2O in ethanol, for example greater than 50 mg/g of WO3-x.xH2O in ethanol. This solution is preferably dark blue and is stored for example in a refrigerator at temperatures of between 2° C. and 10° C., for example between 3° C. and 5° C.

Inks based on tungsten oxide nanoparticles according to the present invention exhibit numerous advantages, of which non-limiting examples include the following:
a) after application: much greater stability over time than that of the applied PEDOT:PSS currently used in OPV (sensitive to air and to acidity in the formulas);
b) versatility in their sector of application; preferred examples include optoelectronics, photovoltaics and security;
c) non-toxicity of the solvents and the nanoparticles;
d) preservation of the intrinsic properties of the nanoparticles; and, in particular,
e) preservation of the electronic properties.

The present invention therefore provides access to tungsten oxide nanoparticles comprising oxalic acid ligands of low sizes. These nanoparticles may take diverse and varied forms; illustrative examples include beads (for example of 1 to 100 nm), rods (for example of length L<200 to 300 nm), wires (for example with lengths of several hundred nanometers or even several microns), disks, stars, pyramids, tetrapods or crystals when they do not have a predefined shape.

According to one variant embodiment of the present invention, the nanoparticles have dimensions of between 1 and 50 nm, preferably between 2 and 20 nm; the Applicant has even accomplished the production, repeatedly and consistently, of nanoparticles with dimensions of less than 10 nm, which constitutes a considerable advance in this sector.

According to one preferred variant embodiment of the present invention, the claimed synthesis method, with its characterizing steps, provided access to nanoparticles with a spheroidal and/or spherical shape. For the present invention and the claims hereinafter, the term “spheroidal shape” signifies that the shape resembles that of a sphere but is not perfectly round (“quasi-spherical”), for example an ellipsoidal shape. The shape and the size of the nanoparticles may be advantageously identified by means of photographs taken by microscope, more particularly by means of a transmission electron microscope (TEM) instrument from ThermoFisher Scientific in accordance with the indications described in the example hereinafter. Therefore, according to this variant embodiment of the present invention, the nanoparticles are spheroidal and are preferably characterized by means of this TEM identification by an average nanoparticle area of between 1 and 20 nm2, preferably between 5 and 15 nm2, and/or by an average nanoparticle perimeter of between 3 and 20 nm, preferably between 5 and 15 nm, and/or an average nanoparticle diameter of between 0.5 and 7 nm, preferably between 1 and 5 nm. According to this variant embodiment of the present invention, the nanoparticles are spheroidal and characterized alternatively by means of a Nanosizer S instrument from Malvern in accordance with the indications described in the example hereinafter, with D50 values of between 1 and 50 nm, preferably between 2 and 20 nm, for example less than 10 nm. D50 is the diameter for which 50% of the nanoparticles by number are smaller.

A particular example of nanoparticle synthesis according to the present invention is described by way of illustration below: in a container with magnetic stirring at 80° C., tungsten hexachloride is mixed with diethylene glycol until a clear, blue-coloured solution is obtained. In another container, oxalic acid is dissolved in water at ambient temperature and with magnetic stirring until a clear, colourless solution is obtained. The aqueous solution of oxalic acid is subsequently added to the tungsten hexachloride solution at 80° C. with magnetic stirring. When the addition is complete, the temperature of the reaction medium is increased to 111° C. and stirring is continued for 3 hours, thus providing access (after settling and washing) to the tungsten trioxide nanoparticles. This synthesis provides access to tungsten trioxide nanospheres having a highly controlled particle size distribution.

The tungsten oxide nanoparticles comprising oxalic acid ligands thus obtained can therefore be formulated advantageously into numerous different inks, allowing diverse and varied applications to be fulfilled.

An additional advantage of the nanoparticles according to the present invention lies in the fact that they can be prepared under non-constricting pressure conditions, for example at pressure conditions which are close to or identical to normal or ambient conditions. Preference is given to remaining at values less than 40% away from normal or ambient pressure condition values. For example, the Applicant has observed that it was preferable to maintain the pressure conditions during the preparation of the nanoparticles (and optionally of the inks) at values which fluctuate by not more than 30%, preferably 15%, around values of normal or ambient conditions. A control of these pressure conditions may therefore advantageously be included in the preparation device in order to meet these conditions.

This advantage associated with preparation under non-constricting conditions is of course also manifested in greater ease of use.

According to one embodiment of the present invention, the ink formulated on the basis of the nanoparticles according to the present invention may advantageously be used in any printing method, more particularly in the following printing methods: inkjet, spray, doctor blade, spin coating, and slot die coating.

The present invention therefore likewise relates to the use of said inks in the stated sectors of “security”, photovoltaics, sensors (for example gas sensors), touch pads, biosensors, and contactless technologies.

It is therefore obvious to a person skilled in the art that the present invention allows embodiments in numerous other specific forms without, however, departing from the field of application of the invention as claimed. Consequently, the present embodiments should be considered as illustrative embodiments, but may be modified in the field defined by the scope of the appended claims.

Examples—the WO3 nanoparticles were obtained in accordance with the particular synthesis example described in the text above. They were kept in ethanol in accordance with the indication in the description above.

Measurement of the % of Organic Phase (Water Trapped in the Crystal Lattice+Oxalic Acid) by Thermogravimetric Analysis

These measurements were made using a Thermogravimetric Analyzer (TGA) instrument from TA Instruments, according to the following characteristics:
a) Measurement method: TGA
b) Temperature rise: 20° C./min
c) Temperature range: Ambient→600° C.

The % of organic phase is between 10 and 15%.

Determination of the Size and Morphology of Nanoparticles+Statistics

These measurements were made using a transmission electron microscope (TEM) instrument from ThermoFisher Scientific, according to the following characteristics:
a) TEM-BF (Bright Field images) were made at 300 kV
b) 50 μm objective lens diaphragm for low magnifications
c) No objective lens diaphragm for high resolution
d) The dimensional measurements were made on TEM images using the Digital Micrograph software.

The measurements are reported in the table below (average over 20 particles).

TABLE 1

| Area | Perimeter | Major diameter | Minor diameter |
|---|---|---|---|
| (nm²) | (nm) | (nm) | (nm) |
| 7 ± 4 | 10 ± 3 | 3 ± 1 | 2 ± 1 |

The table below contains ink compositions (formulated from the same WO3 nanoparticles) which are particularly suited to the electronics sectors.

TABLE 2

| Reference/ | | | | | |
|---|---|---|---|---|---|
| % by weight | WO3 | 2-propanol | Water | Additive | Total |
| SW91011 | 2.5 | 97.5 | 0.0 | 0.0 | 100.0 |
| SW91014 | 2.5 | 15 | 82.5 | 0.0 | 100.0 |
| SW91018 | 2.5 | 14.875 | 82.375 | 0.25 | 100.0 |

The additive is a rheology modifier agent selected from cellulosic rheology modifier agents.

The constituents are indicated in the table along with their concentration by weight for each of the compositions.

The three formulas described above have the following physicochemical characteristics:

Viscosity measurements were carried out for these three ink compositions.

Measurement of Ink Viscosity

These measurements were made using an AR-G2 Rheometer instrument from TA

Instruments, according to the following characteristics:
a) Temperature: 20° C.
b) Shear: 10-40-1000 s-1
c) 1° conical spindle

The measurements are reported in the table below.

TABLE 3

| SW91011 | SW91014 | SW91018 |
|---|---|---|
| 3 cP | 3 cP | 5.5 cP |

Particle size distribution studies were also carried out for these three ink compositions.

These measurements were made using a Nanosizer S instrument from Malvern, according to the following characteristics:
a) Measurement method: DLS
b) Cell type: optical glass
c) Material: WO3
d) Temperature: 20.0° C.
e) Viscosity 3 cP for ink SW91011 and viscosity 3 cP for ink SW91014 and viscosity 5.5 cP for ink SW91018.
f) Refractive index: 1.380 for ink SW91011 and 1.340 for inks SW91014 and SW91018.

The hydrodynamic diameter and D50 values are reported in the table below.

TABLE 4

| | SW91011 | SW91014 | SW91018 |
|---|---|---|---|
| Hydrodynamic | 10-30 nm | 5-10 nm | 5-10 nm |
| diameter | | | |
| D50 | 10-30 nm | 5-10 nm | 5-10 nm |

Surface tension measurements were also carried out for these three ink compositions.

These measurements were made using a tensiometer instrument from Apollo Instruments, according to the following characteristics:
a) Pendant drop method
b) Temperature: 20° C.
c) Density of 0.803 for ink SW91011 and 0.981 for ink SW91014 and 0.985 for ink SW91018.

The surface tension values are reported in the table below.

TABLE 5

| | SW91011 | SW91014 | SW91018 |
|---|---|---|---|
| Surface | 21 mN/m | 31 mN/m | 32 mN/m |
| tension | | | |

The three formulas described above were applied to rigid and flexible supports, and give promising results in terms of roughness and electrical properties.

Roughnesses <5 nm for the three inks were measured on an Alpha Step IQ mechanical profilometer from KLA Tencor.

The following electrical properties were measured by Hall effect on an AMP55T instrument from Microworld for SW91011:

TABLE 6

| WF | Conductivity | Mobility |
|---|---|---|
| [eV] | [S · cm] | [cm2/V · S] |
| 5.2 eV | 4−8E−02 | 21 for 300 nm |

The three formulas were also integrated into multi-layer photovoltaic systems, and the electrical performances are promising.

We are therefore able to envisage their use in the printed electronics sector, more particularly for realizing OPV (organic photovoltaic) modules, as sources for the HTL (hole transport layer) layers.

The inks are particularly suited to the following printing method and following types of OPV structure:

TABLE 7

| Ink | Printing method | OPV structure |
|---|---|---|
| SW91011 | Slot die | Inverse structure |
| SW91014 | Slot die | Normal structure |
| SW91018 | Ink jet | Inverse and normal structure |

1. A method for synthesizing tungsten oxide nanoparticles, comprising the following consecutive steps: a) dissolving a halogenated tungsten compound in an alcohol having a standard boiling point of greater than or equal to 120° C., b) controlling the temperature to a value of between 60° C. and the standard boiling point of the alcohol less 5° C., c) adding oxalic acid, d) controlling the temperature to a value of between 80° C. and the standard boiling point of the alcohol less 5° C., at least greater than the temperatures of step b), and e) obtaining tungsten oxide nanoparticles comprising oxalic acid ligands.

2. The method for synthesizing tungsten oxide nanoparticles according to claim 1, wherein the halogenated tungsten compound is tungsten hexachloride.

3. The method for synthesizing tungsten oxide nanoparticles according to claim 1, wherein the alcohol is a polyol and/or a polyol derivative.

4. The method for synthesizing tungsten oxide nanoparticles according to claim 1, wherein the alcohol is a glycol, a glycol ether, a glycol ether acetate, and/or a mixture of these aforesaid alcohols.

5. The method for synthesizing tungsten oxide nanoparticles according to claim 1, wherein the alcohol is ethylene glycol and/or diethylene glycol.

6. The method for synthesizing tungsten oxide nanoparticles according to claim 1, wherein the solution obtained at the outcome of steps a) and b) is characterized by a molar ratio of the halogenated tungsten compound to the alcohol of between 0.005 and 0.1.

7. The method for synthesizing tungsten oxide nanoparticles according to claim 1, wherein the oxalic acid, before being used in step c), is dissolved in water, with a molar ratio of the oxalic acid to the water of between 0.001 and 0.1.

8. The method for synthesizing tungsten oxide nanoparticles according to claim 1, wherein the tungsten oxide nanoparticles are spheroidal.

9. The method for synthesizing tungsten oxide nanoparticles according to claim 8, wherein the average area of the nanoparticles, by measurement of an image obtained by transmission electron microscopy, is between 1 and 20 nm2, and and/or the average perimeter of the nanoparticles is between 3 and 20 nm, and/or the average diameter of the nanoparticles is between 0.5 and 7 nm.

10. The method for synthesizing tungsten oxide nanoparticles according to claim 8, wherein the nanoparticles have D50 values of less than 10 nm.

11. The method for synthesizing tungsten oxide nanoparticles according to claim 1, wherein the tungsten oxide nanoparticles obtained in step e) are subjected to washing which allows removal of everything not chemically or physically bonded to the nanoparticles, said washing taking place using ethanol, and said tungsten oxide nanoparticles being subsequently kept in ethanol, with a concentration of tungsten oxide nanoparticles in ethanol of greater than 25 mg/g.

12. The method for synthesizing tungsten oxide nanoparticles according to claim 1 wherein the tungsten oxide nanoparticles comprise oxalic acid ligands, and the amount of oxalic acid ligand is controlled via the temperature and/or the concentration of oxalic acid during steps c) and d) of the synthesis method.

13. The method for synthesizing tungsten oxide nanoparticles according to claim 1, wherein the tungsten oxide nanoparticles comprise oxalic acid ligands.

14. The method for synthesizing tungsten oxide nanoparticles according to claim 1, wherein the tungsten oxide nanoparticles comprise oxalic acid ligands in an ink formulation, wherein a liquid phase is always present during the steps of synthesizing the tungsten oxide nanoparticles, and during all of the steps before the formulation of ink.

15. The method for synthesizing tungsten oxide nanoparticles according to claim 1, wherein the alcohol of step a) has a standard boiling point of greater than or equal to 150° C., wherein the temperature of step b) is controlled between 70° C. and 100° C., and wherein the temperature of step d) is at least greater than the temperature of step b).

16. The method for synthesizing tungsten oxide nanoparticles according to claim 6 wherein the molar ratio is between 0.010 and 0.025.

17. The method for synthesizing tungsten oxide nanoparticles according to claim 7 wherein the molar ratio is between 0.005 and 0.020.

18. The method for synthesizing tungsten oxide nanoparticles according to claim 8, wherein the average area of the nanoparticles, by measurement of an image obtained by transmission electron microscopy, is between 5 and 15 nm2, the average perimeter of the nanoparticles is between 5 and 15 nm, and the average diameter of the nanoparticles is between 1 and 5 nm.
